(19) United States
(12) Patent Application Publication
(10) Pub. No.: US 2015/0052853 A1
(43) Pub. Date: Feb. 26, 2015

(54) FILLING PLANT FOR CONTAINERS AND METHOD FOR OPERATING THE FILLING PLANT

(71) Applicant: KRONES AG, Neutraubling (DE)

(72) Inventor: Michael Wasserle, Schierling (DE)

(21) Appl. No.: 14/390,456

(22) PCT Filed: Feb. 21, 2013
(86) PCT No.: PCT/EP2013/053457

§ 371 Date: Oct. 3, 2014

(30) Foreign Application Priority Data
Apr. 17, 2012 (DE) 10 2012 206 295.5

(51) Int. Cl. B67C 7/00; B65C 3/26; B67C 3/02; B65B 3/02

(52) U.S. Cl. CPC B67C 7/002; B65B 3/022; B65C 3/26; B67C 3/02
USPC 53/473; 53/202; 53/135.1; 53/561

(57) ABSTRACT

A filling plant for containers and a method for operating the filling plant. At least two separately controllable transport paths for pressureless container transport, each including at least one single-track container buffer, are provided downstream of a filling machine, and the transport paths can, according to requirements, flexibly be charged with containers having a round or non-round cross-section and in the event of a production failure in one of the transport paths at least the other transport path can still be used for production.

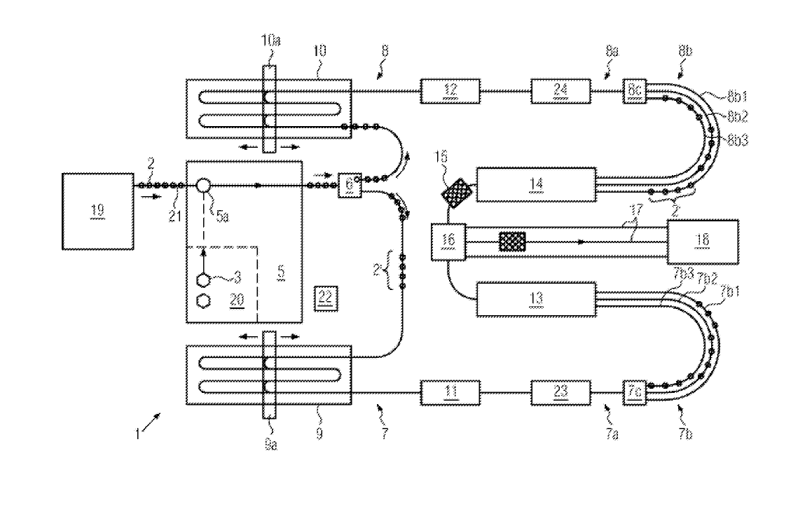

### CROSS-REFERENCE TO RELATED APPLICATION

The present application is the United States national phase of International Patent Application No. PCT/EP2013/053457, filed Feb. 21, 2013, which application claims to German Application No. 10 2012 206 295.5, filed Apr. 17, 2012. The priority application is hereby incorporated by reference.

### FIELD OF THE DISCLOSURE

The present disclosure relates to a filling plant for containers as well as to a method for operating the filling plant.

### BACKGROUND

Filling plants for beverages or the like comprise, as is generally known, a plurality of successive production units, such as filling machines, labelers and packaging machines. As described e.g. in DE 10 2009 040 977 A1, at least some of these production units may be configured as rotary machines that are coupled to one another by means of rotating transfer devices. Alternatively, the production units may also be configured as inline machines and/or connected to one another via linear transport units, distribution devices and product buffers. Plant concepts of the type in question are described e.g. in DE 4 442 586 W4, DE 20 2004 012 848 U1 and EP 2 218 664 A2.

However, as regards a maximization of plant performance, known filling plants are normally optimized for a specific type of container. A change of format to other types of containers is then, if at all, normally only possible with great technical effort and expenditure of time.

In order to meet the increasing demand for a diversification of containers and their configuration variants, e.g. EP 1 299 304 B1 suggests to allow a complex and variable plant operation by intermediately storing, in particular palletizing, the products between closing and packing of the containers. Such plant concepts are flexible, but they require an increased amount of space. Moreover, it is normally nevertheless impossible to convey standard containers having a round cross-section on the same plant line as specially shaped bottles having angular or oval cross-sections. Therefore, it is necessary to separately configure at least certain sections of the filling plant for these types of containers, whereby additional space is required and high investment and operating costs are caused.

Hence, there is a demand for a filling plant that is capable of efficiently processing different types of containers without requiring much space Likewise, operating methods are desired, which allow a fast changeover when a change of products is carried out and short downtimes in the case of malfunction.

### SUMMARY OF THE DISCLOSURE

The disclosed filling plant having a filling machine for filling the containers, at least one packaging machine for packaging the filled containers as well as a controllable distribution device for distributing the filled containers to at least two separately controllable transport paths extending in the direction of the packaging machine. According to the present disclosure, the transport paths are configured for pressureless container transport and comprise each at least one single-track container buffer.

Pressureless container guidance allows standard containers having a round cross-section as well as containers having a non-round cross-section, such as specially shaped bottles having angular or oval cross-sections, to be transported and buffered in the filling plant according to the present disclosure. Pressureless transport and buffering of the containers means here guidance without detrimental back pressure, so that the containers, when transported and buffered, do not press against one another such that a predetermined orientation and/or sequence of the containers along the transport path and the buffer changes. In particular, it means that the rotary position of containers having a non-round cross-section changes such that the containers may become wedged against one another or against guide elements of the production units.

The containers to be filled are in particular beverage bottles. However, the filling plant according to the present disclosure is also suitable for filling containers with agents for household use, pharmaceuticals, sanitary articles or the like. The filled containers are preferably packaged in the form of container packages. The distribution device is controlled in a known manner via a central control unit, in particular on the basis of status messages of production units provided downstream of the distribution device.

With the aid of the transport paths, which are provided at least in duplicate, downstream production units, such as labelers, shrinking tunnels or the like, can be operated with a comparatively high machine performance and high reliability in spite of a pressureless and, at least sectionwise, single-track transport of the containers.

According to a preferred embodiment, the filling machine is configured for filling containers having a round cross-section, which will hereinafter also be referred to as standard containers for the sake of simplicity, and containers having a non-round cross-section, which will hereinafter also be referred to as specially shaped containers for the sake of simplicity. This allows a simple changeover of the filling plant in the case of a change of format of the container type. Separate filling machines for standard containers and specially shaped containers may, however, be provided as well. The different container types can then nevertheless be fed to the controllable distribution device.

According to a preferred embodiment, labelers, in particular sleeve units, are provided in the transport paths downstream of the container buffers. The machine performance of labelers, and in particular of sleeve units, is normally lower than that of filling machines. The machine performance of the filling plant as a whole can be optimized by providing the labelers at least in duplicate and by configuring them such that they can be operated in parallel. The transport paths are thus provided in parallel from the distribution device onwards. The product stream is here distributed to the transport paths preferably in a uniform manner. The parallel provision allows a space-saving mode of arrangement, in particular with labelers operating according to the inline principle.

According to a preferred embodiment, the distribution device is controllable such that, in the case of a reduction of machine performance, in particular a production interruption, it will conduct the containers into the associated container buffer along one of the transport paths, in particular only until said container buffer has been filled, and/or conduct the containers into the at least one additional transport path. This mode of operation will especially be adopted if one of the labelers stands still or if a packaging machine provided at the end of the transport path stands still.

In spite of the partial standstill, it is thus possible to continue operating the part of the filling plant located upstream of the distribution device with an essentially undiminished machine performance, at least until the container buffer has been filled. Production units requiring operation with an essentially unchanged machine performance can then be continued to be operated in a regular fashion, at least until the container buffer has been filled completely. Production interruptions in these parts of the plant can thus be avoided or at least reduced. This also applies to the associated phases of shutting down and/or powering up the respective production units.

Likewise, it would be possible to continue operating the filling plant according to the present disclosure with reduced machine performance, when the container buffer has been filled completely, by interrupting further processing only along the transport path affected by the standstill. Along the at least one further transport path, however, regular processing of the containers can be continued. This mode of operation will especially be of advantage, when the production units, such as the filling machine and/or a blow molding machine, provided upstream of the distribution device can be operated with an adequately reduced machine performance, in particular with half the machine performance. Also in this case, a complete shutdown of the respective production units can be avoided.

According to a preferred embodiment, first sections of the transport paths located between the distribution device and the labelers are single-track sections. This facilitates, on the one hand, the pressureless container guidance along the transport paths and in the container buffers. On the other hand, such single-track container guidance allows an easier exchange of guide elements in the case of a change of format, in particular for allowing respective specially shaped containers of different sizes to be transported such that they are secured against rotation. Especially the transport paths directly upstream and downstream of the container buffer can then be changed over in a particularly fast and economic manner, when a change of products takes place.

The container buffer is preferably configured such that guide elements, such as guide railings, need not be adjusted when a change of format takes place. This can be accomplished e.g. by an adequate combination of conveyor belts. According to a preferred embodiment, second sections of the transport paths located between the labelers and the at least one packaging machine are configured as multi-track sections in the form of separate alleys. The containers can thus be secured against rotational displacement and transported in predetermined spaced relationship with one another through the individual alleys. The alleys are here single-track transport paths, which are provided in parallel and mechanically shielded against one another such that the containers transported in neighboring alleys do not influence one another as regards their orientation and their position with respect to the product stream. Such single-track alleys can e.g. easily be separated from one another by guide railings. With the aid of the separate alleys, the containers can be conducted into the packaging machine in an arrangement which corresponds already to their future arrangement in a container package to be produced.

According to a preferred embodiment, the first and second sections of the transport paths have provided between them alterable switches by means of which the containers can be distributed to the separate alleys in groups, the containers of one and the same group being adapted to be conducted, in particular in spaced relationship with one another, into the respective alley associated therewith. The containers can be distributed in groups to the individual alleys in accordance with their arrangement in a container package to be produced. Due to the fact that the containers are transported along the alleys in spaced relationship with one another, a predetermined orientation of specially shaped containers with respect to the product stream can more easily be maintained during transport, and in particular during transport around bends.

According to a preferred embodiment, the alleys of the second sections merge with respective packaging tracks of the at least one packaging machine, the containers of one and the same group being adapted to be conducted, in particular without any distance between them, into the packaging tracks. Thus, it is more easily possible to transport the containers into the packaging machine carefully and at a position suitable for package production. In particular, the containers are conducted into the packaging machine without any distance between them in groups corresponding to the package to be produced. This also allows specially shaped containers to be conducted into the packaging machine in a particularly reliable manner at a predetermined rotary position.

Container transport along separate alleys is of advantage in particular for specially shaped containers, since such containers cannot become wedged against one another in said separate alleys.

According to a preferred embodiment, the transport paths have associated therewith separate packaging machines. Thus, it is not necessary to unite the containers upstream of the packaging machine on a common transport path. This is advantageous in particular for specially shaped containers so as to prevent said containers from becoming wedged against one another when they are being combined. In addition, the efficiency of the filling plant according to the present disclosure as a whole can be increased in comparison with a packaging machine used for at least two transport paths in common.

Also different packaging machines may be provided, e.g. one packaging machine for cardboard packaging and one packaging machine for film packaging. These packaging machines may each be associated with a specific transport path or they may alternately be associated with one or a plurality of transport paths.

A particularly advantageous embodiment of the filling plant according to the present disclosure further comprises an output-side sorting device, in particular an alterable switch for distributing the containers packaged in the form of container packages to a plurality of sorting alleys, especially for subsequent commissioning of the container packages. Irrespectively of whether the containers in question are standard containers or specially shaped containers, combining separate product streams and sorting for subsequent commissioning can, after the filled containers have been combined so as to form packages, be carried out more reliably than this would be the case if individual containers, in particular specially shaped containers, were combined and sorted. Devices for combining and/or sorting which are known from the prior art can here be used. In this respect, it is of decisive importance that the combining and/or sorting is carried out downstream of the packaging machines.

Another particularly advantageous embodiment of the filling plant according to the present disclosure further comprises a blow molding machine whose machine performance can be adjusted in a variable manner, in particular during ongoing operation. Particularly compact and economic filling plants can thus be realized. In particular blow molding machines that are adjustable with respect to the machine performance additionally provide the advantage that, if there is a reduction of machine performance downstream of the filling machine, also a reduction of machine performance upstream of the filling machine will be realizable so as to avoid a complete shutdown of the filling plant in the case of partial production interruptions and/or in the case of a change of products. In other words, a possibly required reduced machine performance can be realized with an adjustable blow molding machine without the container buffers according to the present disclosure being caused to fill completely. Likewise, it would be imaginable to reduce the machine performance of blow molding machines provided upstream of the filling machine only after at least one container buffer provided downstream of the distribution device has been filled completely. This allows the filling plant according to the present disclosure to be operated in a particularly economic and flexible mode.

Likewise, at least two blow molding machines may be provided in the filling plant according to the present disclosure. A particularly advantageous combination is e.g. a first blow molding machine for standard containers and a second blow molding machine for specially shaped containers. Also filling plants are imaginable, in which a first blow molding machine, used e.g. for standard containers, is connected to the filling machine by means of an input-side transport path, e.g. an air transport path, and in which a second blow molding machine, used e.g. for producing specially shaped containers, is configured together with the filling machine as a common machine block. The filling machine may then comprise on the input side a conventional alterable switch so as to allow effective further processing of the containers produced by the first blow molding machine or the second blow molding machine.

In accordance with a presently disclosed method for operating the filling plant, the stream of filled containers is, during regular operation of the plant, distributed to the transport paths in groups, in particular in equal shares. To this end, the containers are e.g. alternately distributed to the transport paths in groups comprising each 2 to 12 containers. Large groups comprising each 6 to 12 containers, e.g. 8 to 10 containers, are particularly practicable and advantageous, since they reduce the number of the required switching operations of the distribution device.

A distribution to the transport paths in equal shares allows, in particular during regular operation of the filling plant according to the present disclosure, an optimized machine performance of the plant. According to a particularly advantageous distribution mode the containers are distributed to the transport path such that the number of charged alleys corresponds to a width of the packages to be produced. This means that the containers intended e.g. for packages comprising 3×4 containers will be distributed to three alleys or four alleys. The amount of containers comprised in a group need not necessarily correspond to the respective length of the packages to be produced. For example, the groups may each comprise 10 containers and the packages may have a length of 4 containers.

According to a preferred embodiment, the track width of the transport paths is adapted to at least one non-round container cross-section so as to transport the containers such that they are secured against rotation. This means that specially shaped containers can e.g. be laterally guided always on the same circumferential segments of their cross-section. The containers can thus be prevented from becoming misaligned, from wedging and/or from blocking, and transport at an adequate position can thus be guaranteed up to the packaging machine. This means that in particular specially shaped containers can be transported to the packaging machine at a specific rotary position relative to the product stream, said rotary position corresponding preferably already to their orientation in the container package to be produced.

According to a preferred embodiment, the filling plant is continued to be operated, in particular with an undiminished filling performance, if the production is interrupted along one of the transport paths, until the container buffer in the transport path affected by the interruption has been filled. This allows, at least in the case of comparatively short production interruptions or production changeovers, a regular operation with undiminished machine performance upstream of the distribution device. In particular, shut-down and start-up phases can be avoided or at least reduced upstream. The reliability of the filling plant in its entirety can be increased in this way. Likewise, the machine performance in its entirety and, consequently, the cost effectiveness of the filling plant are increased.

According to a preferred embodiment, the containers are pressureless distributed to a plurality of single-track alleys upstream of the packaging machine, and the number of alleys charged in this way corresponds to a package size to be produced in the packaging machine. By means of said pressureless transport, different types of containers, in particular standard containers as well as specially shaped containers, can equally be transported from the filling machine to the packaging machine. Distribution in dependence upon the size of a package is particularly cost-effective, since the use of additional sorting and aligning units for the different containers can be dispensed with.

### BRIEF DESCRIPTION OF THE DRAWING

A preferred embodiment of the filling plant according to the present disclosure is shown in the drawing.

### DETAILED DESCRIPTION

The only FIGURE shows a preferred embodiment of the filling plant 1 according to the present disclosure in a schematic top view. According to this FIGURE, the filling plant 1 for filling containers 2, 3 with a liquid product, e.g. a beverage or the like, comprises a filling machine 5 for filling and closing the containers 2, 3, and a distribution device 6 provided downstream of the filling machine 5 and used for distributing the containers 2, 3 to two separately controllable transport paths 7, 8, each having provided therein at least one container buffer 9, 10. The container buffers 9, 10 are followed by labelers 11, 12 as well as packaging machines 13, 14 for producing container packages 15. These container packages 15 are supplied to a collecting and distributing device 16, so that the container packages 15 can be distributed to sorting tracks 17 provided downstream of the collecting and distributing device 16 and fed to a commissioning facility 18.

The containers 2, 3 are e.g. plastic containers of different types. The schematically indicated containers are containers 2 with a round cross-section, so-called standard containers, and containers 3 with a polygonal cross-section, so-called specially shaped containers. An advantage of the filling plant 1 according to the present disclosure is that it is suitable for different container cross-sections. The container types described are therefore only of an exemplary nature.

The transport paths 7, 8 each comprise first sections 7a, 8a on the input side configured as single-track sections for pressureless transport of the containers 2, 3. In addition, the transport paths 7, 8 comprise second sections 7b, 8b on the output side, each configured as a multi-track section for pressureless transport of the containers 2, 3. For distributing the containers 2, 3 from the single-track first section 7a, 8a to the individual tracks of the second section 7b, 8b, which are configured e.g. in the form of separate alleys 7b1 to 7b3, 8b1 to 8b3, alterable switches 7c, 8c or suitable distributing means are provided. For the sake of clarity, the FIGURE shows the transport paths associated with the alleys, without showing the lateral boundaries of the alleys, e.g. railings.

As is additionally schematically indicated in the FIGURE, the distribution device 6 distributes the containers 2, 3 in groups to the transport paths 7, 8. In the example shown, the containers 2 are alternately distributed to the two transport paths 7, 8 in groups 2′, each group comprising 4 containers. This corresponds to a preferred mode of operation, when the filling plant 1 according to the present disclosure functions adequately, i.e. the containers 2, 3 are preferably distributed in equal shares to the two transport paths 7, 8 by the distribution device 6. The two labelers 11, 12 associated with the transport paths 7, 8 are thus subjected to equal loads.

Between the distribution device 6 and the labelers 11, 12, the containers 2, 3 pass through the respective intermediate container buffer 9, 10. Depending on the operating condition of the filling plant, said container buffer can be adjusted to different buffer capacities in the manner known, as described e.g. in DE 20 2004 012 848 U1. In the FIGURE, this is indicated by adjustable container guides 9a, 10a. Load fluctuations in the two transport paths 7, 8 can thus be compensated for, so can, at least for a certain period of time, a reduction of performance or an interruption of production in one of the two transport paths 7, 8.

If, for example, one labeler 11 should temporarily fail due to malfunction or a change of labels or the like, the distribution device 6 can first continue to distribute the incoming stream of containers in the direction of the two container buffers 9, 10, at least until the container buffer 9 upstream of the labeler 11 that is not ready for use has been filled completely. Meanwhile, the supply of containers 2, 3 to the other labeler 12 will be duly continued.

Provided that the individual transport paths 7, 8 have an adequate transport capacity, it would be possible to conduct all the containers 2, 3 in the direction of the labeler 12 that is capable of operating, when the container buffer 9 has been filled. With an undiminished flow of containers from the filling machine 5 towards the distribution device 6, the number of containers 2, 3 entering the container buffer 10 per unit time will then be twice as high as during normal, regular operation. Since the discharge from the container buffer 10 is limited due to the machine performance of the labeler 12 and lies normally below the machine performance of the filling machine 5, also the container buffer 10 will fill continuously due to the partial standstill of the transport path 7.

The machine performance upstream of the distribution device 6 can be maintained without any changes, at least until one of the container buffers 9, 10 has been filled completely, possibly until both container buffers 9, 10 have been filled.

It follows that, depending on the capacity of the container buffers 9, 10, a buffer period is obtained, in which the failure of a production unit within one of the transport paths 7, 8 can be compensated such that a reduction of the machine performance or an interruption of the production upstream of the distribution device 6 can be prevented. This is especially advantageous insofar as it is no longer necessary to shut down and subsequently power up these plant components, e.g. blow molding machines, within the buffer period. This is precisely that which allows comparatively expensive downtimes of the filling plant 1 according to the present disclosure to be avoided.

As indicated in the FIGURE, the filling plant according to the present disclosure preferably comprises at least one blow molding machine 19, 20. In the example shown, separate blow molding machines 19, 20 are provided for producing different containers 2, 3. For example, a container 2 having a standard cross-section, in particular a round container cross-section, is produced with a first blow molding machine 19. Preferably, a second blow molding machine 20 is used for producing a container 3 having a non-round cross-section, e.g. a polygonal, in particular rectangular, or oval cross-section.

As is additionally illustrated by the FIGURE, at least one of the blow molding machines 19, 20 may be configured together with the filling machine 5 as a common machine block. Likewise, at least one of the blow molding machines 19, 20 may be connected to the filling machine 5 via an input-side transport path 21, e.g. an air transport path of a known structural design. The variant shown here is only of an exemplary nature. In principle, arbitrary blow molding machines 19, 20 can be coupled to the filling machine 5.

It would also be imaginable to produce at least one type of containers outside the filling plant 1. An input-side alterable switch 5a of the filling machine 5 is only schematically indicated in the FIGURE, said alterable switch being adapted to be used for advancing different incoming container streams to further processing.

The filling plant 1 described is particularly suitable for processing different types of containers, in particular for processing containers 2 having a round cross-section and containers 3 having a non-round cross-section. Suitable filling machines 5 are known from the prior art and, consequently, they need not be described here in more detail. The decisive aspect is that the transport paths 7, 8 and the associated container buffers 9, 10 are configured for pressureless transport of the containers 2, 3. Only this will guarantee a failure-free operation when containers 3 having a non-round cross-section are filled. The pressureless transport especially allows a failure-free buffering of different types of containers in the container buffers 9, 10. The latter are single-track buffers and operate also without back pressure, as described e.g. in DE 20 2004 012 848 U1.

For controlling the filling plant 1 according to the present disclosure, a central control unit 22 is preferably provided, which communicates in particular with the distribution device 6, the container buffers 9, 10, the labelers 11, 12 and the production units upstream of the distribution device 6, such as the filling machine 5 and the blow molding machines 19, 20 (the communication paths are not shown in the FIGURE for the sake of clarity). It is here of decisive importance that, if a partial production interruption is detected downstream of the distribution device 6, the distribution device 6 will, with the aid of the control unit 22, be able to effectively prevent the containers 2, 3 from being supplied to the transport path 7, 8 affected by the production interruption and to effectively conduct the container stream into a container buffer 9, 10, downstream of which the production process still takes place in due form.

The communication between the control unit 22 and the container buffers 9, 10 also allows to detect the degree of filling or the remaining capacity of the container buffers 9, 10 so as to interrupt the stream of containers flowing into the respective container buffer 9, 10, if the latter has been filled completely. In this case, communication with the production units provided upstream of the distribution device 6 allows said production units to be shut down, if necessary.

The labelers 11, 12 are e.g. sleeve units whose machine performance is normally much lower than that of the production units upstream of the distribution device 6. Hence, the division of the container stream at the distribution device 6 allows, on the one hand, an increase in the machine performance of the filling plant 1 according to the present disclosure during regular operation, and, on the other hand, a reduction of downtimes of the filling plant 1 as a whole. In addition, the fact that the container buffers 9, 10 exist in duplicate provides sufficient buffer capacity even in the case of containers 3 having non-round cross-sections.

For the sake of completeness, additional production units 23, 24 are indicated in the FIGURE in the area of the first sections 7a, 8a of the transport paths 7, 8. These production units may e.g. be shrinking tunnels or the like.

In the second section 7b, 8b of the transport paths 7, 8 the containers 2, 3 are distributed to the alleys 7b1 to 7b3 and 8b1 to 8b3 in groups and advanced such that the containers 2, 3 of neighboring alleys do not interfere with one another. This means that the containers 2, 3 maintain a predetermined rotary position and a predetermined distance relative to one another. It may here be of advantage to transport the containers 2, 3, after they have been distributed to the individual alleys, in closely spaced relationship with one another so as to prevent successive containers 2, 3 e.g. from influencing one another during transport around bends or in similar conveying modes.

Immediately prior to entering the packaging machine 13, 14, the containers 2, 3 are, however, brought into contact with one another, so that they come in at a position corresponding to the container package 15 to be produced. Packaging of the containers 2, 3 can be simplified in this way. The number of alleys 7b1 to 7b3 and 8b1 to 8b3 shown is only exemplary. Preferably, the number of juxtaposed alleys corresponds to a maximum package width, i.e. to the number of containers 2, 3 which are to be combined side by side in one of the packages 15. Depending on the actual package size to be produced, only the respective required alleys 7b1 to 7b3 and 8b1 to 8b3 will be charged with containers 2, 3.

The alleywise supply of containers 2, 3 is advantageous in particular when the containers 3 in question do not have a round cross-section. It is then not necessary to combine these containers, which come from different transport paths 7, 8, upstream of a common packaging machine. In particular in the case of non-round cross-sections, such combining of containers 3 is problematic in view of the fact that the containers 3 may become misaligned and/or wedged. In other words, an advantageous variant will especially be one where the number of packaging machines 13, 14 corresponds to the number of separate transport paths 7, 8.

In order to allow a flexible and reliable operation of the filling plant 1, the transport paths 7, 8 are separately controllable. This means that, depending on the machine performance required and/or in the event that the production in one of the transport paths 7, 8 should partially fail, the container stream can be distributed to the transport paths 7, 8 with the aid of the distribution device 6 in a flexible and effective manner as regards an optimum load on the plant.

As is additionally indicated in the FIGURE, the filling plant according to the present disclosure, which comprises at least two transport paths 7, 8, can be realized in a particularly advantageous manner with production units configured as inline machines downstream of the distribution device 6. In principle, rotary machines are, however, also imaginable at the locations in question. This also applies to the distribution devices and alterable switches of the filling plant 1 according to the present disclosure. Suitable distribution devices of the inline type are e.g. linear distributing switches or roof-type dividers. Suitable distribution devices of the rotary type are e.g. retaining starwheels or clamping starwheels. The mode of operation of such distribution devices is known and need not be explained here consequently.

By means of the above described filling plant 1 and the above described method for operating the filling plant 1 according to the present disclosure, especially by means of the above described buffers for the containers 2, 3 used in the case of a partial failure of the filling plant downstream of the distribution device 6, particularly flexible and reliable production conditions can be established.

1. A filling plant for containers, comprising:
a filling machine for filling the containers;
at least one packaging machine for packaging the filled containers; and
a controllable distribution device for distributing the filled containers to at least two separately controllable transport paths extending in the direction of the packaging machine, the transport paths being configured for pressureless container transport, each transport path including at least one single-track container buffer.

2. The filling plant according to claim 1, and the filling machine is configured for filling containers with round and non-round cross-sections.

3. The filling plant according to claim 1, and labelers are provided in the transport paths downstream of the container buffers.

4. The filling plant according to claim 1, the distribution device being controllable such that, in the case of a reduction of the machine performance, the distribution device will conduct the containers into the associated container buffer along one of the transport paths, and/or conduct the containers into the at least one additional transport path.

5. The filling plant according to claim 3, and first sections of the transport paths located between the distribution device and the labelers are single-track sections.

6. The filling plant according to claim 4, and second sections of the transport paths located between the labelers and the at least one packaging machine are configured as multi-track sections in the form of separate alleys.

7. The filling plant according to claim 6, wherein the first and second sections of the transport paths have provided between them alterable switches by means of which the containers can be distributed to the separate alleys in groups, the containers of one and the same group being adapted to be conducted into the respective alley associated therewith.

8. The filling plant according to claim 7, and the alleys of the second sections merge with respective packaging tracks of the at least one packaging machine, the containers of one and the same group being adapted to be conducted into the packaging tracks.

9. The filling plant according to claim 1, and the transport paths have associated therewith separate packaging machines.

10. The filling plant according to claim 9, and an output-side sorting device for distributing the containers packaged in the form of container packages to a plurality of sorting alleys.

11. The filling plant according to claim 1, and a blow molding machine whose machine performance is variable.

12. A method for operating the filling plant according to claim 1, and, during regular operation of the plant, the containers are distributed to the transport paths in groups.

13. The method according to claim 12, and the track width of the transport paths is adapted to at least one non-round container cross-section so as to transport the containers such that they are secured against rotation.

14. The method according to claim 12, and, if the production is interrupted along one of the transport paths, the filling plant is continued to be operated until the container buffer (9) of the transport path affected by the interruption has been filled.

15. The method according to claim 12, the containers being pressurelessly distributed to a plurality of single-track alleys upstream of the packaging machine, and the number of alleys charged in this way corresponds to a package size to be produced in the packaging machine.

16. The filling plant according to claim 1, and the container comprises beverage bottles.

17. The filling plant according to claim 1, the filled containers being in the form of the container packages.

18. The filling plant according to claim 3, and the labelers comprise sleeve units.

19. The filling plant according to claim 4, and the reduction of the machine performance comprises a production interruption.

20. The filling plant according to claim 4, and the distribution device will conduct the containers into the associated container buffer along one of the transport paths only until said container buffer has been filled.

21. The filling plant according to claim 7, and the containers of the one and the same group are conducted in spaced relationship with one another into the respective alley associated therewith.

22. The filling plant according to claim 8, and the containers of the one and the same group are conducted into the respective alley associated therewith without any distance between adjacent containers.

23. The filling plant according to claim 10, and the output-side sorting device comprises an alterable switch.

24. The filling plant according to claim 10, and the output-side sorting device distributes the containers for subsequent commissioning of the container packages.

25. The filling plant according to claim 11, and said machine performance is variable during ongoing operations.

26. The method according to claim 12, and the containers are distributed to the transport paths in equal shares.

27. The filling plant according to claim 14, and the filling plant is continued to be operated with an undiminished filling performance.
